(19) United States
(12) Patent Application Publication
(10) Pub. No.: US 2025/0207989 A1
(43) Pub. Date: Jun. 26, 2025

(54) TWO-DIMENSIONAL PRESSURE SENSOR AND TWO-DIMENSIONAL PRESSURE SENSOR ARRAY

(71) Applicant: SAMSUNG ELECTRONICS CO., LTD., Suwon-si (KR)

(72) Inventors: Hye Yeon YANG, Suwon-si (KR); Sang Joon KIM, Suwon-si (KR)

(73) Assignee: SAMSUNG ELECTRONICS CO., LTD., Suwon-si (KR)

(21) Appl. No.: 18/666,229

(22) Filed: May 16, 2024

(30) Foreign Application Priority Data
Dec. 26, 2023 (KR) 10-2023-0190965

(51) Int. Cl. G01L 5/164; G01L 1/14; G01L 1/18; G01L 5/00; G01L 5/162; G01L 5/165; G01L 5/169

(52) U.S. Cl. CPC G01L 5/164; G01L 1/146; G01L 1/18; G01L 5/0076; G01L 5/162; G01L 5/165; G01L 5/169

(57) ABSTRACT

A two-dimensional (2D) pressure sensor includes a substrate, a pressure deformation layer on the substrate and configured to deform due to external pressure applied by a workpiece, a magnetic bump on the pressure deformation layer and configured to move due to the external pressure applied by the workpiece, a proximity sensor in the pressure deformation layer and configured to detect at least one of movement of the workpiece and movement the magnetic bump, and a tactile sensor in the pressure deformation layer and configured to detect deformation of the pressure deformation layer.

### CROSS-REFERENCE TO RELATED APPLICATION(S)

This application is based on and claims priority to Korean Patent Application No. 10-2023-0190965, filed on Dec. 26, 2023, in the Korean Intellectual Property Office, the disclosure of which is incorporated herein by reference in its entirety.

### BACKGROUND

### 1. Field

The disclosure relates to a two-dimensional (2D) pressure sensor capable of detecting information about pressure applied by a workpiece.

### 2. Description of Related Art

With the advancement of automation technology, the next-generation functional robots acquire external environmental information using sensors mounted thereon within a working space of the robots. The next-generation functional robots may work autonomously by extracting, by themselves, information required for tasks and by determining statuses.

As the need for accuracy in automation tasks increases with the development of robot intelligence, distinctions between industrial robots and collaborative robots are less certain, and flexibility in robotic operations increases.

Related art automation robots may perform tasks by visually checking work statuses and establishing work plans, such that the robots exhibit repeatability for coordinate-based control on specific tasks. However, if the robots perform tasks using only existing visual information, information for identifying correlations between robots and a workpiece may be insufficient due to equipment that visually obscures collected visual information or due to a limited space for using sensors.

Accordingly, in order to supplement blind spots in visual information, there is an increasing need for sensors capable of physical interaction during non-contact/contact. Particularly, in an environment where cameras cannot be used, there is also a growing need for highly reliable two-dimensional (2D) pressure sensors in technology for defect detection during an automation process.

For example, there is a need for technology to detect defects in a wafer or die process which occur due to contact during semiconductor processing, as well as technology for sensing alignment during actual processing so that tasks designed based on visual information may be accurately performed. In addition, as irregularity increases in robotic operations, there is a need for obtaining information about the environment during contact.

### SUMMARY

Provided is a two-dimensional (2D) pressure sensor capable of accurately identifying a workpiece and accurately sensing the alignment of the workpiece and the distribution of force due to deformation, allowing for precise operation.

Additional aspects will be set forth in part in the description which follows and, in part, will be apparent from the description, or may be learned by practice of the presented embodiments of the disclosure.

According to an aspect of the disclosure, a 2D pressure sensor may include a substrate, a pressure deformation layer on the substrate and configured to deform due to external pressure applied by a workpiece, a magnetic bump on the pressure deformation layer and configured to move due to the external pressure applied by the workpiece, a proximity sensor in the pressure deformation layer and configured to detect at least one of movement of the workpiece and movement the magnetic bump, and a tactile sensor in the pressure deformation layer and configured to detect deformation of the pressure deformation layer.

The proximity sensor may include a high-frequency oscillator circuit configured to detect a change in inductance of an inductive coil caused by a change in magnetic field due to movement of the magnetic bump.

The proximity sensor may include a Hall element configured to measure a change in a Hall voltage caused by a change in magnetic field due to movement of the magnetic bump.

The proximity sensor may include a magnetoresistor configured to detect a change in resistance caused by a change in magnetic field due to movement of the magnetic bump.

The tactile sensor may include a piezo-resistive pressure sensor configured to detect a change in resistance of a piezoresistor caused by pressure due to deformation of the pressure deformation layer.

The tactile sensor may include an electrostatic capacitance-type pressure sensor configured to detect a change in electrostatic capacitance between electrodes, and the change in electrostatic capacitance may be caused by pressure due to deformation of the pressure deformation layer.

The 2D pressure sensor may include partition walls, where the tactile sensor may be between the partition walls, and the partition walls may include a material that is more robust than a material of the pressure deformation layer.

The 2D pressure sensor may include a protective layer, where the magnetic bump may include an embedded portion that is embedded in the pressure deformation layer and a protruding portion that protrudes from the pressure deformation layer, and the protective layer may at least partially cover the protruding portion of the magnetic bump.

The pressure deformation layer may include a polymer material.

The 2D pressure sensory may include a controller configured to obtain information about pressure applied by the workpiece, based on a signal output from the proximity sensor and a signal output from the tactile sensor.

According to an aspect of the disclosure, a 2D pressure sensor array may include a substrate, a pressure deformation layer on the substrate and configured to deform due to external pressure applied by a workpiece, a plurality of magnetic bumps on the pressure deformation layer and arranged in a matrix, the plurality of magnetic bumps being configured to move due to the external pressure applied by the workpiece, a plurality of proximity sensors in the pressure deformation layer and respectively corresponding to the plurality of magnetic bumps, the plurality of proximity sensors being configured to detect movement of the workpiece or movement of at least one magnetic bump of the plurality of magnetic bumps, and a plurality of tactile sensors in the pressure deformation layer and respectively corresponding to the plurality of magnetic bumps, the plurality of tactile sensors being configured to detect deformation of the pressure deformation layer.

At least one of proximity sensor of the plurality of proximity sensors may include a high-frequency oscillator circuit configured to detect a change in inductance of an inductive coil caused by a change in magnetic field due to movement of at least one magnetic bump of the plurality of magnetic bumps.

At least one proximity sensor of the plurality of proximity sensors may include a Hall element configured to measure a change in a Hall voltage caused by a change in magnetic field due to movement of at least one magnetic bump of the plurality of magnetic bumps.

At least one proximity sensor of the plurality of proximity sensors may include a magnetoresistor configured to detect a change in resistance caused by a change in magnetic field due to movement of at least one magnetic bump of the plurality of magnetic bumps.

At least one tactile sensor of the plurality of tactile sensors may include a piezo-resistive pressure sensor configured to detect a change in resistance of a piezoresistor caused by pressure due to deformation of the pressure deformation layer.

At least one tactile sensor of the plurality of tactile sensors may include an electrostatic capacitance-type pressure sensor configured to detect a change in electrostatic capacitance between electrodes, where the change in electrostatic capacitance may be caused by pressure due to deformation of the pressure deformation layer.

The 2D pressure sensor array may include a plurality of partition walls, where each tactile sensor of the plurality of tactile sensors may be between at least two partition walls of the plurality of partition walls, and the plurality of partition walls may include a material that is more robust than a material of the pressure deformation layer.

The 2D pressure sensor array may include a protective layer, where at least one magnetic bump of the plurality of magnetic bumps may include an embedded portion that is embedded in the pressure deformation layer and a protruding portion that protrudes from the pressure deformation layer, and the protective layer may fully cover the protruding portion of the at least one magnetic bump.

The pressure deformation layer may include a polymer material.

The 2D pressure sensor array may include a controller configured to obtain information about pressure applied by the workpiece, based on signals output from the plurality of proximity sensors and signals output from the plurality of tactile sensors, and estimate a direction and distribution of force, a surface deformation state, and an alignment state based on the obtained information about the pressure applied by the workpiece.

According to an aspect of the disclosure, a 2D pressure sensor may include a substrate, a pressure deformation layer configured to deform based on a pressure applied by a workpiece, a magnetic bump on the pressure deformation layer and configured to move based on being in proximity with the workpiece, a proximity sensor in the pressure deformation layer and configured to detect at least one of movement of the workpiece and movement of the magnetic bump, and a tactile sensor in the pressure deformation layer and configured to detect deformation of the pressure deformation layer.

The workpiece may include a magnetic property and the magnetic bump may be configured to move based on an interaction with the magnetic property of the workpiece without contacting the workpiece.

The magnetic bump may be configured to move based on the workpiece contacting the magnetic bump.

The magnetic bump may include a first portion embedded in the pressure deformation layer and a second portion protruding from the pressure deformation layer, and the magnetic bump may be configured to move based on the workpiece contacting the second portion of the magnetic bump.

The 2D pressure sensor may include a controller configured to obtain information about the pressure applied by the workpiece, based on a signal output from the proximity sensor and a signal output from the tactile sensor.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a cross-sectional view illustrating a two-dimensional (2D) pressure sensor according to some embodiments of the present disclosure;

FIG. 2 is a diagram illustrating an example of a proximity sensor according to some embodiments of the present disclosure;

FIG. 3 is a diagram illustrating an example of a proximity sensor according to some embodiments of the present disclosure;

FIG. 4 is a diagram illustrating an example of a proximity sensor according to some embodiments of the present disclosure;

FIGS. 5A and 5B are diagrams illustrating examples of a tactile sensor according to some embodiments of the present disclosure;

FIG. 6 is a diagram illustrating an example of a tactile sensor according to some embodiments of the present disclosure;

FIG. 7 is a cross-sectional view illustrating a (2D pressure sensor array according to some embodiments of the present disclosure;

FIG. 8 is a plan view illustrating a 2D pressure sensor array according to some embodiments of the present disclosure;

FIG. 9 is a diagram illustrating a signal processing operation of a controller according to some embodiments of the present disclosure; and

FIG. 10 is a diagram illustrating an example of applying a 2D pressure sensor array to a wafer handling robot according to some embodiments of the present disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Hereinafter, example embodiments will be described in detail with reference to the accompanying drawings. The embodiments described below are merely exemplary, and various modifications are possible from these embodiments. In the following drawings, the same reference numerals refer to the same components, and the size of each component in the drawings may be exaggerated for clarity and convenience of description.

In the following description, when a component is referred to as being “above” or “on” another component, it may be directly on an upper, lower, left, or right side of the other component while making contact with the other component or may be above an upper, lower, left, or right side of the other component without making contact with the other component.

Terms such as first, second, etc. may be used to describe various components, but are used only for the purpose of distinguishing one component from another component. These terms do not limit the difference in the material or structure of the components.

The terms of a singular form may include plural forms unless otherwise specified. In addition, when a certain part “includes” a certain component, it means that other components may be further included rather than excluding other components unless otherwise stated

In addition, terms such as “unit” and “module” described in the specification may indicate a unit that processes at least one function or operation, and this may be implemented as hardware or software, or may be implemented as a combination of hardware and software.

The use of the term “the” and similar designating terms may correspond to both the singular and the plural.

Operations of a method may be performed in an appropriate order unless explicitly described in terms of order. In addition, the use of all illustrative terms (e.g., etc.) is merely for describing technical ideas in detail, and the scope is not limited by these examples or illustrative terms unless limited by the claims.

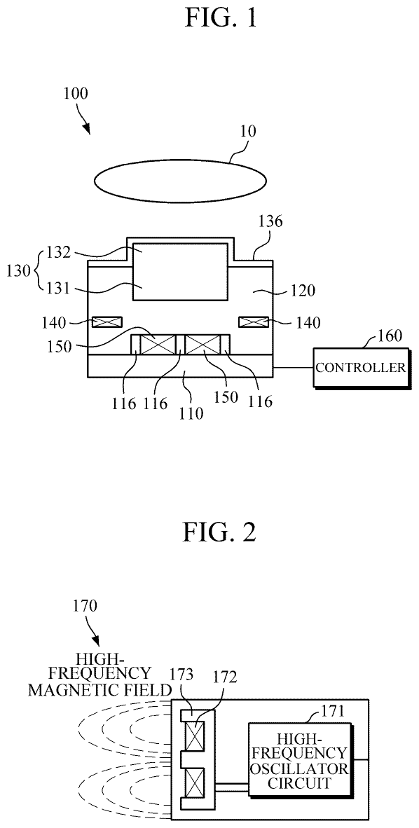

FIG. 1 is a cross-sectional view illustrating a two-dimensional (2D) pressure sensor according to some embodiments of the present disclosure.

Referring to FIG. 1, a 2D pressure sensor 100 according to some embodiments of the present disclosure may include a substrate 110, a pressure deformation layer 120, a magnetic bump 130, a proximity sensor 140, and a tactile sensor 150.

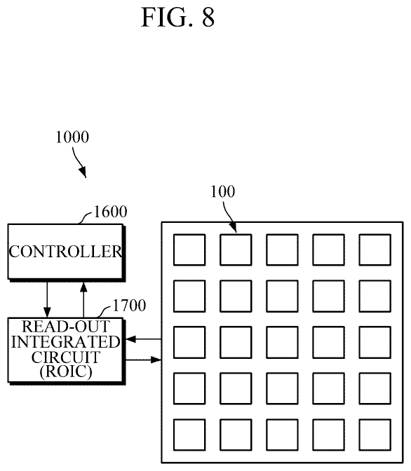

A sensing circuit electrically connected to the proximity sensor 140 and the tactile sensor 150 may be formed on the substrate 110. The sensing circuit may be connected to a read-out integrated circuit (IC) (ROIC) (e.g., the ROIC 1700 of FIG. 8).

The ROIC may generate a bias voltage or current for driving the proximity sensor 140 and the tactile sensor 150, and may acquire signals from the proximity sensor 140 and the tactile sensor 150. The ROIC may be mounted on the substrate 110. The ROIC may be controlled by a controller 160.

The controller 160 may acquire information about pressure, applied by a workpiece 10, by processing the signals output from the proximity sensor 140 and the tactile sensor 150. The controller 160 may estimate the pressure information by applying an estimation model that defines a correlation between the signals acquired by the ROIC and the pressure information. The estimation model may be defined by various methods, such as a linear function equation, linear/nonlinear regression analysis, and the like.

The pressure deformation layer 120 may be stacked on the substrate 110 and may be deformed due to external pressure applied by the workpiece 10. The pressure deformation layer 120 may be deformed when external pressure is applied, and then, may be restored after the external pressure is removed. The pressure deformation layer 120 may be made of a polymer material. The Young's modulus of the polymer material may be set such that the pressure deformation layer 120 may perform its original functions.

The magnetic bump 130 may be supported by the pressure deformation layer 120 and may be moved due to external pressure applied by the workpiece 10. The magnetic bump 130 may be made of a magnetic nanocomposite and the like to have magnetism.

Due to contact of the workpiece 10 with the magnetic bump 130 causing the magnetic bump 130 to move, the magnetic bump 130 may cause a change in magnetic field, thereby allowing the proximity sensor 140 to detect the contact of the workpiece 10 by detecting the magnetic field change. Although the workpiece 10 may not have magnetism, the magnetic bump 130 may allow the proximity sensor 140 to detect the contact of the workpiece 10.

The magnetic bump 130 may partially protrude from the pressure deformation layer 120. A portion 131 of the magnetic bump 130 may be embedded in the pressure deformation layer 120 and may be fixed to the pressure deformation layer 120, and another portion 132 of the magnetic bump 130 may protrude from the pressure deformation layer 120. The magnetic bump 130 may have various shapes, such as a hexahedral or cylindrical shape, and the like.

The magnetic bump 130, having the protruding portion 132, may be configured to easily contact the workpiece 10. The protruding portion 132 of the magnetic bump 130 may be covered by a protective layer 136. The protective layer 136 may protect the protruding portion 132 of the magnetic bump 130 by contacting the workpiece 10 that approaches the magnetic bump 130. The protective layer 136 may be made of metal oxide and the like.

The proximity sensor 140 may be disposed in the pressure deformation layer 120 and may detect movement of the workpiece 10 or movement of the magnetic bump 130 caused by the workpiece 10. The proximity sensor 140 may detect the approach of the workpiece 10 having magnetism (i.e., having magnetic properties) in a non-contact manner. When a workpiece 10 having no magnetism approaches, the proximity sensor 140 may detect information about the contact of the workpiece 10 by detecting movement of the magnetic bump 130. When the workpiece 10 contacts the magnetic bump 130 (e.g., via the protective layer 136), the proximity sensor 140 may detect relatively micro-contact pressure compared to the tactile sensor 150.

In other words, the magnetic bump 130 may be configured to move based on being in proximity with the workpiece 10, such that, when the workpiece 10 has magnetic properties, the magnetic bump 130 may be configured to move based on a magnetic integration with the magnetic properties of the workpiece 10 without contacting the workpiece 10, and such that, when the workpiece 10 does or does not have magnetic properties, but physically contacts the magnetic bump 130 (either directly or indirectly via an intermedia layer such as the protective layer 136), the magnetic bump 130 may be configured to move based on the pressure caused by the contact of the workpiece 10. Alternatively or additionally, the proximity sensor 140 may be configured to detect the workpiece 10 having magnetism by detecting the magnetic properties of the workpiece 10 (i.e., the proximity sensor 140 may be configured to detect the magnetic properties of the workpiece 10 directly without detecting movement of the magnetic bump 130).

The tactile sensor 150 may be disposed in or below the pressure deformation layer 120 and may detect deformation of the pressure deformation layer 120. When the workpiece 10 applies pressure to the magnetic bump 130 such that the magnetic bump 130 is moved, the pressure deformation layer 120 that supports the magnetic bump 130 may be deformed. In this case, the tactile sensor 150 may detect the contact pressure, applied by the workpiece 10, by detecting deformation of the pressure deformation layer 120, where the deformation of the pressure deformation layer 120 may be caused by movement of the magnetic bump 130 based on physical contact or magnetic interaction with the workpiece 10.

The tactile sensor 150 may be disposed at a position corresponding to the magnetic bump 130 to accurately detect the pressure of the workpiece 10. The tactile sensor 150 may be disposed at a greater distance from the magnetic bump 130 than the proximity sensor 140. One or more tactile sensors 150 (e.g., both tactile sensors 150 shown in FIG. 1) may be provided. A plurality of tactile sensors 150 may also be arranged in a matrix to correspond to the magnetic bump 130, so as to accurately detect the pressure of the workpiece 10.

The tactile sensor 150 may be disposed between partition walls 116 that are made of a material that is more robust than the pressure deformation layer 120, and may detect deformation of the pressure deformation layer 120. The partition walls 116 may be made of a polymer material (and the like) having a higher Young's modulus than the pressure deformation layer 120.

The partition walls 116 may be minimally deformed when the pressure deformation layer 120 is deformed, such that the tactile sensor 150 may precisely detect the pressure applied to the deformation layer 120. In addition, in the case where a plurality of tactile sensors 150 are arranged, the partition walls 116 may prevent the tactile sensors 150 from affecting each other, thereby reducing crosstalk between the tactile sensors 150.

The 2D pressure sensor 100 having the above configuration may be manufactured using micro-electromechanical system (MEMS) technology and the like.

An example of operation of the 2D pressure sensor according to some embodiments of the present disclosure is described below.

When the workpiece 10 approaches the magnetic bump 130 of the 2D pressure sensor 100, the proximity sensor 140 may detect the approach of the workpiece 10 in a non-contact manner if the workpiece 10 has magnetism.

Then, when the workpiece 10 applies pressure (i.e., physical or magnetic pressure) to the magnetic bump 130 such that the magnetic bump 130 is moved, the proximity sensor 140 may detect the contact or proximity of the workpiece 10 by detecting a change in magnetic field due to the movement of the magnetic bump 130. In addition, when the pressure deformation layer 120 is deformed due to the movement of the magnetic bump 130, the tactile sensor 150 may detect a change in pressure applied by the workpiece 10 by detecting an amount of deformation of the pressure deformation layer 120.

As described above, the 2D pressure sensor 100 according to some embodiments of the present disclosure may detect, in real time, a pressure change during contact starting from a non-contact proximate location where a visual dead zone or blind spot occurs, thereby accurately identifying a correlation with the workpiece 10.

FIG. 2 is a diagram illustrating an example of a proximity sensor according to some embodiments of the present disclosure. The proximity sensor 170 may be implemented as the proximity sensor 140 in FIG. 1.

Referring to FIG. 2, the proximity sensor 170 may include a high-frequency oscillator circuit 171 configured to detect a change in inductance of an inductive coil 172 caused by a change in magnetic field due to movement of the magnetic bump 130 and/or due to proximity of a workpiece 10 having magnetic properties.

The high-frequency oscillator circuit 171 may include the inductive coil 172 wound on a ferromagnetic core 173 and connected to a capacitor. When the high-frequency oscillator circuit 171 allows a magnetic material to enter a high-frequency magnetic field generated around the inductive coil 172, an eddy current may flow in the magnetic material according to electromagnetic induction (Faraday's law), causing heat loss.

Accordingly, an inductance value and loss resistance of the inductive coil 172 may be changed, and these changes may be output as a change in oscillation frequency or oscillation amplitude of the high-frequency oscillator circuit 171. Based on the change in oscillation frequency or oscillation amplitude, the proximity sensor 170 may detect movement of the workpiece 10 having magnetism or physical movement of the magnetic bump 130.

A winding shape or size of the inductive coil 172, and the number of turns of the inductive coil 172, and the like, may be set variously depending on a proximity distance and proximity resolution. The inductive coil 172 may be made of a material, such as copper (Cu), gold (Au), silver (Ag), liquid metal, and the like.

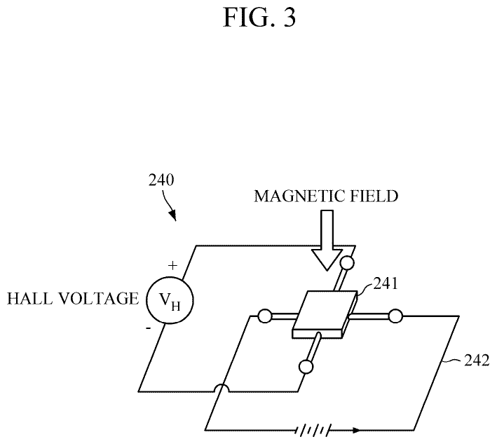

FIG. 3 is a diagram illustrating an example of a proximity sensor according to some embodiments of the present disclosure. The proximity sensor 240 may be implemented as the proximity sensor 140 in FIG. 1.

Referring to FIG. 3, a proximity sensor 240 may include a Hall element 241 configured to measure a change in Hall voltage caused by a change in magnetic field due to movement of the magnetic bump 130 and/or due to proximity of a workpiece 10 having magnetic properties. The Hall element 241 may be a semiconductor device using the Hall Effect (e.g., a Hall Effect sensor). When a magnetic field is applied perpendicularly to an electrical conductor through which a current flows, a Hall Effect may occur in which a voltage is generated in a direction perpendicular to both the current and the magnetic field, and this voltage may be referred to as the Hall voltage.

When a control current or a control voltage is applied to two terminals of the Hall element 241 via a driving circuit 242, and a magnetic field is applied perpendicularly to the Hall element 241, the Hall voltage may be generated and output between the other two terminals of the Hall element 241. Based on the Hall voltage, the proximity sensor 240 may detect movement of the workpiece 10 having magnetism or physical movement the magnetic bump 130.

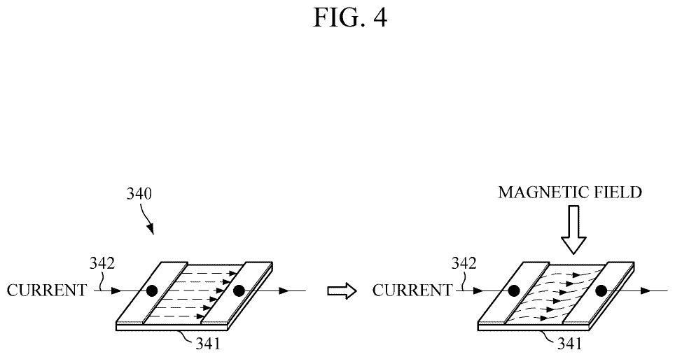

FIG. 4 is a diagram illustrating an example of a proximity sensor according to some embodiments of the present disclosure. The proximity sensor 340 may be implemented as the proximity sensor 140 in FIG. 1.

Referring to FIG. 4, a proximity sensor 340 may include a magnetoresistor 341 configured to detect a resistance change caused by a change in magnetic field due to movement of the magnetic bump 130. The magnetoresistor 341 may be an element using a magnetoresistance effect in which the resistance of a material changes due to a magnetic field. A semiconductor magnetoresistive element may be used as the magnetoresistor 341.

When a control current or a control voltage is applied to two terminals of the magnetoresistor 341 via a driving circuit 342, and a magnetic field is applied to the magnetoresistor 341, a Lorentz force may be exerted, which is proportional to the size of the magnetic field, such that a path through which a current flows may be bent. Then, a length of the path through which the current flows may increase, thereby increasing the resistance of the magnetoresistor 341. The size of a magnetic field may be detected based on the resistance change.

Based on the resistance change, the proximity sensor 340 may detect movement of the workpiece 10 having magnetism or physical movement of the magnetic bump 130. In addition to these proximity sensors 140, 240, and 340, the proximity sensor may be configured in various manners as long as the proximity sensor may perform the above functions.

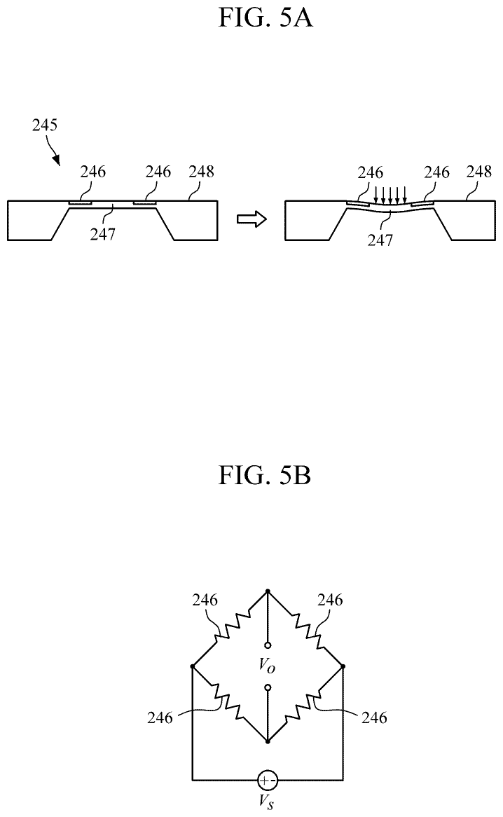

FIGS. 5A and 5B are diagrams illustrating examples of a tactile sensor according to some embodiments of the present disclosure. The tactile sensor 245 of FIGS. 5A and 5B may be implemented as the tactile sensor 150 shown in FIG. 1.

Referring to FIGS. 5A and 5B, the tactile sensor 245 may include a piezo-resistive pressure sensor configured to detect a change in resistance of a piezoresistor 246 caused by pressure applied due to deformation of the pressure deformation layer 120. The piezo-resistive pressure sensor may be manufactured using MEMS technology.

The piezo-resistive pressure sensor may measure pressure by using four (or fewer or more) piezoresistors 246 formed at a boundary between a thin film 247 and a substrate 248, and by detecting a change in resistance of the piezoresistors 246 which is caused when the thin film 247 is deformed by pressure. The four piezoresistors 246 may be connected into the Wheatstone bridge circuit, and when pressure is applied, the thin film 247 may be deformed such that resistance values of the piezoresistors 246 change, and an output signal proportional to the pressure may be obtained by the bridge circuit. Based on the output signal, the tactile sensor 245 may detect the deformation of the pressure deformation layer 120.

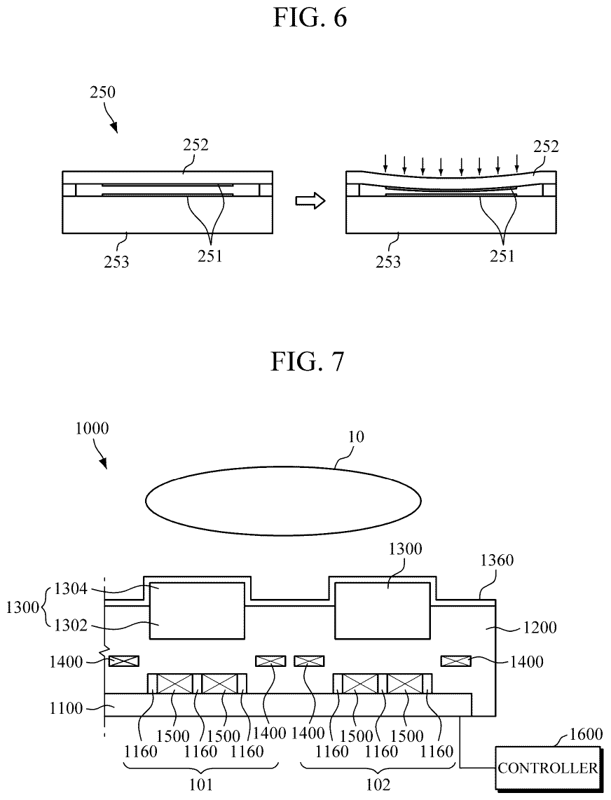

FIG. 6 is a diagram illustrating an example of a tactile sensor according to some embodiments of the present disclosure. The tactile sensor 250 of FIG. 6 may be implemented as the tactile sensor 150 shown in FIG. 1.

Referring to FIG. 6, a tactile sensor 250 may include an electrostatic capacitance-type pressure sensor configured to detect a change in electrostatic capacitance between electrodes 251 which is caused by pressure applied due to deformation of the pressure deformation layer 120. The electrostatic capacitance-type pressure sensor may be manufactured using MEMS technology.

In the capacitance-type pressure sensor, the electrodes 251 may be formed to face each other on a thin film 252 and a substrate 253, and a distance between the electrodes 251 may change due to external pressure, causing a change in electrostatic capacitance between the electrodes 251. Pressure may be detected by converting the change in electrostatic capacitance into an electrical signal. Based on the detected pressure, the tactile sensor 250 may detect the deformation of the pressure deformation layer 120. In addition to these tactile sensors 150, 245 and 250, the proximity sensor 140 may be configured in various manners as long as the tactile sensor may perform the above functions.

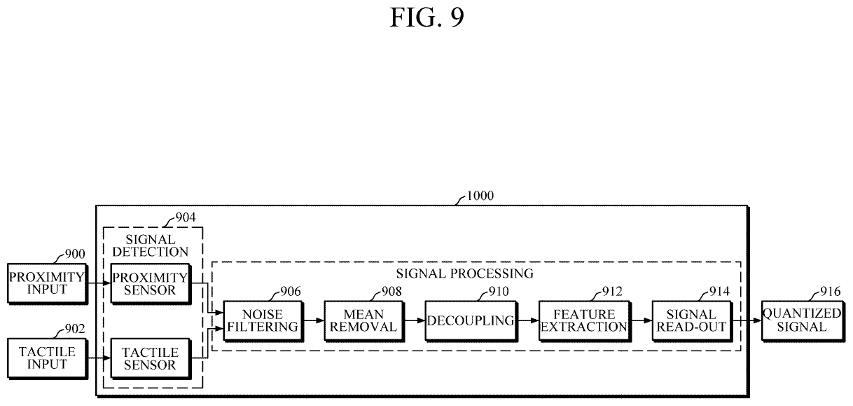

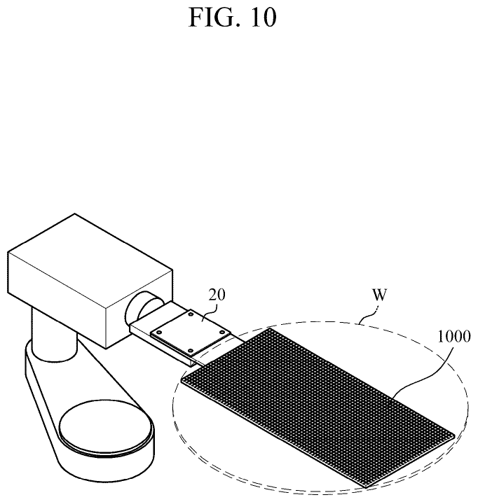

FIG. 7 is a cross-sectional view illustrating a 2D pressure sensor array according to some embodiments of the present disclosure. FIG. 8 is a plan view illustrating a 2D pressure sensor array according to some embodiments of the present disclosure. FIG. 9 is a diagram illustrating a signal processing operation of a controller according to some embodiments of the present disclosure.

Referring to FIGS. 7 to 9, a 2D pressure sensor array 1000 may include a substrate 1100, a pressure deformation layer 1200, magnetic bumps 1300, proximity sensors 1400, and tactile sensors 1500.

The 2D pressure sensor array 1000 may include 2D pressure sensors (e.g., pressure sensor 100 of FIG. 1) arranged in a matrix. That is, the 2D pressure sensor array 1000 may include, but is not limited to, the pressure sensor 101 and the pressure sensor 102. The respective 2D pressure sensors may form a pixel in the 2D pressure sensor array 1000.

The substrate 1100 may include the substrates 110 of the 2D pressure sensors (as described in FIG. 1) which are connected and integrated into one body. The substrate 1100 may be formed similarly to the substrate 110 of the 2D pressure sensor 100 of FIG. 1.

The pressure deformation layer 1200 may be stacked on the substrate 1100 and may be deformed due to external pressure applied by the workpiece 10. The pressure deformation layer 1200 may include the pressure deformation layers 120 of the 2D pressure sensor 100 of FIG. 1 which are connected and integrated into one body. The pressure deformation layer 1200 may be formed similarly to the pressure deformation layer 120 of the 2D pressure sensor 100 of FIG. 1.

The magnetic bumps 1300 may be supported by the pressure deformation layer 1200 and may be arranged in a matrix. The magnetic bumps 1300 may be moved due to external pressure applied by the workpiece 10. The magnetic bumps 1300 may be arranged to correspond, one by one, to pixels of the 2D pressure sensor array 1000. The respective magnetic bumps 1300 may be formed similarly to the magnetic bump 130 of the 2D pressure sensor 100 of FIG. 1.

The magnetic bumps 1300 may partially protrude from the pressure deformation layer 1200. For example, a magnetic bump 1300 may include an embedded portion 1302 and a protruding portion 1304. The protruding portion 1304 may be covered by a protective layer 1360. The protective layer 1360 may be formed similarly to the protective layer 136 of the 2D pressure sensor 100 of FIG. 1.

The proximity sensors 1400 may be disposed in the pressure deformation layer 1200 so as to correspond to the respective magnetic bumps 1300, and may detect movement of the workpiece 10 or movement the magnetic bumps 1300. The proximity sensors 1400 may not only detect proximity or contact of the workpiece 10, but also distinguish normal/shear proximity of the workpiece 10.

The proximity sensors 1400 may be arranged to correspond, one by one, to the pixels of the 2D pressure sensor array 1000. The respective proximity sensors 1400 may be formed similarly to the proximity sensors 140, 170, 240, and 340 described above. The proximity sensors 1400 may have a proximity distance of 0 nm to 100 nm and a proximity resolution of 5 um to 2 mm.

The tactile sensors 1500 may be disposed in the pressure deformation layer 1200 so as to correspond to the respective magnetic bumps 1300, and may detect deformation of the pressure deformation layer 1200. The tactile sensors 1500 may not only detect pressure of the workpiece 10, but also distinguish normal/shear pressure of the workpiece 10.

One or a plurality of tactile sensors 1500 may be arranged to correspond to pixels in the 2D pressure sensor array 1000. The respective tactile sensors 1500 may be formed similarly to the tactile sensors 150, 245 and 250 described above.

The tactile sensor 1500 may be disposed between partition walls 1160 made of a material that is more robust than the pressure deformation layer 1200, and may detect deformation of the pressure deformation layer 1200. The partition walls 1160 may be formed similarly to the partition wall 116 described above.

The tactile sensor 1500 may have a dynamic range of 0 N to 10 N, linearity of R²>0.95, sensitivity of >0.1 kPa⁻¹, spatial resolution of 1 um to 4000 um (e.g., 10 um to 2000 um), and a minimum detection force of 1 mN to IN (e.g., ≤3 mN).

A controller 1600 may obtain information about pressure, applied by the workpiece 10, by processing signals output from the proximity sensors 1400 and the tactile sensors 1500, to estimate a direction and distribution of force, a surface deformation state, and an alignment state.

Referring to FIG. 9, the controller 1600 may sequentially perform noise filtering in operation 906 and mean removal in operation 908 on the signals detected in operation 904 by the proximity sensors 1400 (i.e., the proximity input 900) and the tactile sensors 1500 (i.e., the tactile input 902), and then, may separate the signals of the proximity sensors 1400 and the tactile sensors 1500 by decoupling in operation 910. In operation 912, the controller 1600 may extract a feature from the separated signal and, in operation 914, read out the extracted feature to output a quantized signal 916.

The controller 1600 may estimate a force direction by applying an estimation model that defines a correlation between the acquired signal and the force direction. The controller 1600 may estimate force distribution by applying an estimation model that defines a correlation between the acquired signal and the force distribution. The controller 1600 may estimate a surface deformation state by applying an estimation model that defines a correlation between the acquired signal and the surface deformation state.

The controller 1600 may estimate an alignment state by applying an estimation model that defines a correlation between the acquired signal and the alignment state. The estimation model may be defined by various methods, such as linear function equation, linear/nonlinear regression analysis, and the like.

As described above, the 2D pressure sensor array 1000 according to some embodiments of the present disclosure may accurately identify the outline of the workpiece 10, and may accurately detect the direction and distribution of force applied by the workpiece 10 and the surface deformation state and alignment state of the workpiece 10.

FIG. 10 is a diagram illustrating an example of applying a 2D pressure sensor array to a wafer handling robot according to some embodiments of the present disclosure.

Referring to FIG. 10, the 2D pressure sensor array 1000 may be mounted on a robot hand 20 handling a wafer W. Warpage of the wafer W may occur during a semiconductor process. The 2D pressure sensor array 1000 mounted on the robot hand 20 may detect the warpage of the wafer W and flatness of the wafer W during transport of the wafer W.

As the warped wafer, which may not be well-aligned with the robot hand 20, may cause an error during transport of the wafer W, the 2D pressure sensor array 1000 may detect the alignment of the wafer W.

In addition, the 2D pressure sensor array 1000 may provide full automation of all non-automated areas (maintenance, hand-on experiment). Particularly, the 2D pressure sensor array 1000 may allow for manufacture of an intelligent robot hand for cube 3D in a three-dimensional stacking process for advanced packaging (AVP).

In addition, the 2D pressure sensor array 1000 may be applied to electronic skin, touch pads, touch displays, flexible displays, wearable displays, haptic devices, energy harvesting device, robotics, weight detection sensors, and the like.

As used in connection with various embodiments of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to some embodiments, the module may be implemented in a form of an application-specific integrated circuit (ASIC).

Various embodiments as set forth herein may be implemented as software including one or more instructions that are stored in a storage medium that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to some embodiments, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

At least one of the devices, units, components, modules, units, or the like represented by a block or an equivalent indication in the above embodiments including, but not limited to, FIGS. 1, 2, and 7-9 may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein).

Each of the embodiments provided in the above description is not excluded from being associated with one or more features of another example or another embodiment also provided herein or not provided herein but consistent with the disclosure.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A two-dimensional (2D) pressure sensor, comprising:
a substrate;
a pressure deformation layer on the substrate and configured to deform due to external pressure applied by a workpiece;
a magnetic bump on the pressure deformation layer and configured to move due to the external pressure applied by the workpiece;
a proximity sensor in the pressure deformation layer and configured to detect at least one of movement of the workpiece and movement the magnetic bump; and
a tactile sensor in the pressure deformation layer and configured to detect deformation of the pressure deformation layer.

2. The 2D pressure sensor of claim 1, wherein the proximity sensor comprises a high-frequency oscillator circuit configured to detect a change in inductance of an inductive coil caused by a change in magnetic field due to movement of the magnetic bump.

3. The 2D pressure sensor of claim 1, wherein the proximity sensor comprises a Hall element configured to measure a change in a Hall voltage caused by a change in magnetic field due to movement of the magnetic bump.

4. The 2D pressure sensor of claim 1, wherein the proximity sensor comprises a magnetoresistor configured to detect a change in resistance caused by a change in magnetic field due to movement of the magnetic bump.

5. The 2D pressure sensor of claim 1, wherein the tactile sensor comprises a piezo-resistive pressure sensor configured to detect a change in resistance of a piezoresistor caused by pressure due to deformation of the pressure deformation layer.

6. The 2D pressure sensor of claim 1, wherein the tactile sensor comprises an electrostatic capacitance-type pressure sensor configured to detect a change in electrostatic capacitance between electrodes, wherein the change in electrostatic capacitance is caused by pressure due to deformation of the pressure deformation layer.

7. The 2D pressure sensor of claim 1, further comprising partition walls,
wherein the tactile sensor is between the partition walls, and
wherein the partition walls comprise a material that is more robust than a material of the pressure deformation layer.

8. The 2D pressure sensor of claim 1, further comprising a protective layer,
wherein the magnetic bump comprises an embedded portion that is embedded in the pressure deformation layer and a protruding portion that protrudes from the pressure deformation layer, and
wherein the protective layer at least partially covers the protruding portion of the magnetic bump.

9. The 2D pressure sensor of claim 1, wherein the pressure deformation layer comprises a polymer material.

10. The 2D pressure sensor of claim 1, further comprising a controller configured to obtain information about pressure applied by the workpiece, based on a signal output from the proximity sensor and a signal output from the tactile sensor.

11. A two-dimensional (2D) pressure sensor array comprising:
a substrate;
a pressure deformation layer on the substrate and configured to deform due to external pressure applied by a workpiece;
a plurality of magnetic bumps on the pressure deformation layer and arranged in a matrix, the plurality of magnetic bumps being configured to move due to the external pressure applied by the workpiece;
a plurality of proximity sensors in the pressure deformation layer and respectively corresponding to the plurality of magnetic bumps, the plurality of proximity sensors being configured to detect movement of the workpiece or movement of at least one magnetic bump of the plurality of magnetic bumps; and
a plurality of tactile sensors in the pressure deformation layer and respectively corresponding to the plurality of magnetic bumps, the plurality of tactile sensors being configured to detect deformation of the pressure deformation layer.

12. The 2D pressure sensor array of claim 11, wherein at least one of proximity sensor of the plurality of proximity sensors comprises a high-frequency oscillator circuit configured to detect a change in inductance of an inductive coil caused by a change in magnetic field due to movement of at least one magnetic bump of the plurality of magnetic bumps.

13. The 2D pressure sensor array of claim 11, wherein at least one proximity sensor of the plurality of proximity sensors comprises a Hall element configured to measure a change in a Hall voltage caused by a change in magnetic field due to movement of at least one magnetic bump of the plurality of magnetic bumps.

14. The 2D pressure sensor array of claim 11, wherein at least one proximity sensor of the plurality of proximity sensors comprises a magnetoresistor configured to detect a change in resistance caused by a change in magnetic field due to movement of at least one magnetic bump of the plurality of magnetic bumps.

15. The 2D pressure sensor array of claim 11, wherein at least one tactile sensor of the plurality of tactile sensors comprises a piezo-resistive pressure sensor configured to detect a change in resistance of a piezoresistor caused by pressure due to deformation of the pressure deformation layer.

16. The 2D pressure sensor array of claim 11, wherein at least one tactile sensor of the plurality of tactile sensors comprises an electrostatic capacitance-type pressure sensor configured to detect a change in electrostatic capacitance between electrodes, wherein the change in electrostatic capacitance is caused by pressure due to deformation of the pressure deformation layer.

17. The 2D pressure sensor array of claim 11, further comprising a plurality of partition walls,
wherein each tactile sensor of the plurality of tactile sensors is between at least two partition walls of the plurality of partition walls, and
wherein the plurality of partition walls comprise a material that is more robust than a material of the pressure deformation layer.

18. The 2D pressure sensor array of claim 11, further comprising a protective layer,
wherein at least one magnetic bump of the plurality of magnetic bumps comprises an embedded portion that is embedded in the pressure deformation layer and a protruding portion that protrudes from the pressure deformation layer, and
wherein the protective layer fully covers the protruding portion of the at least one magnetic bump.

19. The 2D pressure sensor array of claim 11, wherein the pressure deformation layer comprises a polymer material.

20. The 2D pressure sensor array of claim 11, further comprising a controller configured to:
obtain information about pressure applied by the workpiece, based on signals output from the plurality of proximity sensors and signals output from the plurality of tactile sensors; and
estimate a direction and distribution of force, a surface deformation state, and an alignment state based on the obtained information about the pressure applied by the workpiece.

21. A two-dimensional (2D) pressure sensor, comprising:
a substrate;
a pressure deformation layer configured to deform based on a pressure applied by a workpiece;
a magnetic bump on the pressure deformation layer and configured to move based on being in proximity with the workpiece;
a proximity sensor in the pressure deformation layer and configured to detect at least one of movement of the workpiece and movement of the magnetic bump; and
a tactile sensor in the pressure deformation layer and configured to detect deformation of the pressure deformation layer.

22. The 2D pressure sensor of claim 21, wherein the workpiece comprises a magnetic property, and
wherein the magnetic bump is configured to move based on an interaction with the magnetic property of the workpiece without contacting the workpiece.

23. The 2D pressure sensor of claim 21, wherein the magnetic bump is configured to move based on the workpiece contacting the magnetic bump.

24. The 2D pressure sensor of claim 23, wherein the magnetic bump comprises a first portion embedded in the pressure deformation layer and a second portion protruding from the pressure deformation layer, and
wherein the magnetic bump is configured to move based on the workpiece contacting the second portion of the magnetic bump.

25. The 2D pressure sensor of claim 21, further comprising a controller configured to obtain information about the pressure applied by the workpiece, based on a signal output from the proximity sensor and a signal output from the tactile sensor.
